(19) United States
(12) Patent Application Publication
(10) Pub. No.: US 2015/0012594 A1
(43) Pub. Date: Jan. 8, 2015

(54) METHOD FOR FORMING A NETWORK

(71) Applicant: Alexandra Winkler-Teufel, Balgheim (DE)

(72) Inventor: Alexandra Winkler-Teufel, Balgheim (DE)

(73) Assignee: APPBYYOU GMBH, Balgheim (DE)

(21) Appl. No.: 14/369,262

(22) PCT Filed: Dec. 30, 2011
(86) PCT No.: PCT/EP2011/006609

§ 371 Date: Aug. 13, 2014

(51) Int. Cl. H04L 29/06; G06Q 50/00

(52) U.S. Cl. CPC H04L 65/403; H04L 69/16; G06Q 50/01
USPC 709/204

(57) ABSTRACT

The invention relates to a method for forming a network with a first mobile computer (10) having at least one first main communications program (12) and a second mobile computer (14) having at least one second main communications program (16) and a first contact program (18) associated with the first main communications program (12), the first main communications program (12) sending at least social data to the first contact program (18).

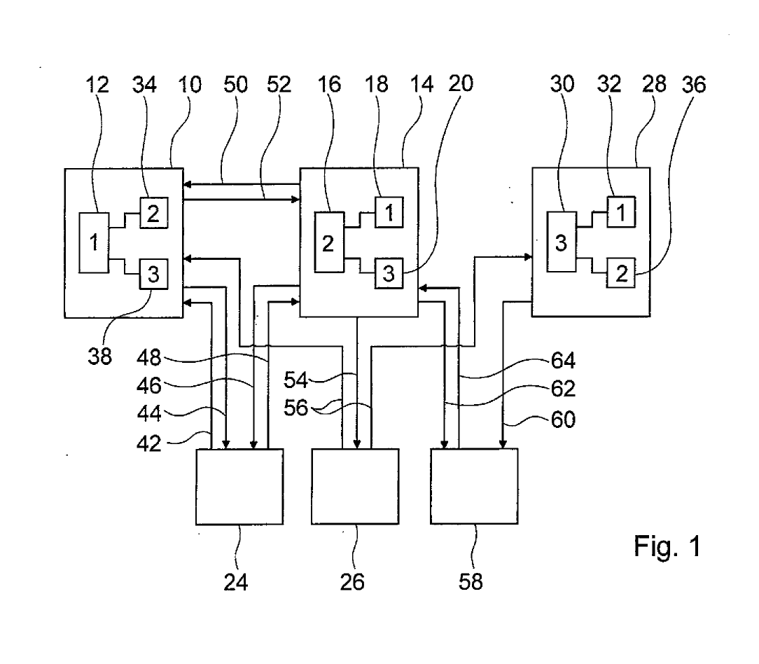

### STATE OF THE ART

A method has already been proposed in which a server and mobile computers each having a main communication program form a network for transmission of social data. In this connection, the mobile computers communicate exclusively with the server. The server stores the social data.

The invention is particularly based on the task of making available a method for transmission of social data from one mobile computer to another mobile computer, in which method the social data are stored in decentralized manner. This task is accomplished, according to the invention, by means of the characteristics of claim 1. Further embodiments are evident from the dependent claims.

### Advantages of the Invention

A method for forming a network, particularly a social network, having a first mobile computer that has at least a first main communication program, and a second mobile computer that has at least a second main communication program and a first contact program associated with the first main communication program, to which the first main communication program transmits at least social data, is proposed.

The expression “for forming a social network” is supposed to particularly be understood to mean that during operation, at least the two computers, preferably, however, more than two computers, form a computer network, by way of which users of the computers carry out social contacts by way of transmission of social data. Preferably, the mobile computers, particularly the main communication programs and the at least one contact program of the computers of the social network communicate directly with one another, at least in one operating state. It is advantageous if the mobile computers communicate by way of TCP/IP and/or UDP in at least one operating state. It is particularly advantageous if the mobile computers communicate by way of WAP push messages in at least one operating state. A “mobile computer” should particularly be understood to mean a computer that is intended to be carried by a user during operation. Preferably, the mobile computer comprises a rechargeable battery to provide power during mobile operation.

Preferably, the mobile computer has a communication interface that transmits the social data to a communication interface of another computer. Preferably, the mobile computer is configured as a mobile computer that appears practical to a person skilled in the art, but advantageously as a mobile telephone, as a smartphone, as a tablet computer and/or as a notebook. In particular, a “communication interface” should be understood to mean an interface that transmits and receives data during operation. The communication interface has at least one antenna for data transmission. The communication interface is configured as an interface that appears practical to a person skilled in the art, preferably, however, as a USB interface, as a LAN interface, as a W-LAN interface, as a Zigbee interface, as a Bluetooth interface and/or advantageously as a mobile radio interface, for example as a UMTS interface, a GPRS interface and/or as an LTE interface. In particular, a “main communication program” should be understood to mean an application of a mobile computer that outputs an input field to the user in at least one operating state, for input of social data, particularly by way of a display of the mobile computer. Preferably, the main communication program transmits social data to multiple contact programs, particularly those installed on different mobile computers, in at least one operating state.

Preferably, the user configures the main communication program with his/her user data. Preferably, the user configures the main communication program with his/her user data. Preferably, only one user configures the main communication program with his/her data. In this way, the user individualizes the main communication program. Alternatively, the main communication program could have a user administration that allows individualization of the main communication program by multiple users. A “contact program” should particularly be understood to mean a program that produces a social network to the user of a main communication program by means of association with the main communication program. Preferably, the first contact program at least receives social data from the first main communication program in at least one operating state. Preferably, the first contact program receives social data only from the first main communication program. Alternatively, the first contact program could allow reception of social data from the first main communication program with the second main communication program installed on the same mobile computer, for example in that it makes a contact address and/or a key for decryption and, in particular, for encryption available. In particular, the expression that “the contact program is associated with a main communication program” should be understood to mean that every contact program has a contact address of, in particular, precisely one main communication program installed on another computer. Preferably, the contact program communicates with precisely one main communication program installed on another computer, and, in particular, with the main communication program installed on the same computer. Preferably, the contact program is associated with precisely one user of the social network, for example with a person, a company, an employee, a customer, and product and/or another user that appears practical to a person skilled in the art. In particular, the contact program has at least one additional function, for example a posting system, a data system, a game and/or another function that appears practical to a person skilled in the art. “Social data” should particularly be understood to mean data that a user of the first main communication program passes on to one or more other users of the social network, such as, for example, text messages, status reports, videos, images, data from games and/or other data that appear practical to a person skilled in the art. The term “transmit” should particularly be understood to mean that the first main communication program transmits social data input by the user, by way of the communication interface of the first mobile computer and the communication interface of the second mobile computer, to the second main communication program and/or, advantageously, to the first contact program. Preferably, the first main communication program transmits the social data directly to the first contact program. “Directly” should particularly be understood to mean that the social data are not temporarily stored between the first main communication program and the first contact program. By means of the method according to experience, a decentralized social network can be made available, which allows the user particularly extensive control of his/her social data. Furthermore, advantageous addition of social contacts is possible, specifically in that their contact program is installed.

In a further embodiment, it is proposed that the first contact program stores a contact address of the first mobile computer in memory, thereby making particularly convenient formation of a social network possible. A “contact address” should particularly be understood to mean an address of the network by means of which a datum can be sent to the first mobile computer. The contact address is preferably configured as a static address that appears practical to a person skilled in the art, but preferably as a static IP address and/or as a telephone number. Alternatively, the contact program could query a dynamic address of the first mobile computer by means of the contact address, by way of a server to which the main communication program of the first mobile computer, in particular, sends the dynamic address of the first mobile computer. Preferably, an installation file of the contact program comprises the contact address of the mobile computer of the associated main communication program. It is advantageous if the contact program stores the changed contact address in memory in the event of a change in the contact address.

Furthermore, it is proposed that the first contact program stores at least public social data of the first main communication program in memory, thereby making it possible to associate the contact program with a user of the social network in particularly simple manner. In particular, “public social data” should be understood to mean social data that a user inputting the social data designates as being public. Preferably, the public social data comprise at least a user name of the user, an identification value of the main communication program and/or, in particular, a contact address of a mobile computer in which the main communication program is installed. The term “social data of the first main communication program” should particularly be understood to mean that the first contact program stores the same social data in memory as the first main communication program, at least in part.

Furthermore, it is proposed that the first contact program sends an authorization request to the first main communication program, thereby making it possible to produce a contact of the social network in simple, convenient, and secure manner, in terms of design. In particularly, an “authorization request” should be understood to mean a message to a user of the first main communication program, by means of which the user of the first main communication program is requested to configure transmission of private social data to the first contact program.

Furthermore, it is proposed that the first main communication program stores a contact address of the second mobile computer in memory, thereby advantageously making it possible for the main communication program to communicate with the first contact program.

Furthermore, it is proposed that the first main communication program particularly transmits private social data to the first contact program, thereby making it possible to distribute new and/or changed social data in the social network, in terms of design. In particular, “private social data” should be understood to mean social data that can only be viewed by some of the users of the social network. Preferably, the user of the social network can restrict the group of users who can view the private social data.

In an advantageous embodiment of the invention, it is proposed that the first contact program stores private social data, in particular, in encrypted form, thereby advantageously protecting the social data from unauthorized access. “Store in encrypted form” should particularly be understood to mean that the private social data, in particular, before being stored in memory, are converted to a form that is protected against unauthorized reading, particularly by means of an encryption method that appears practical to a person skilled in the art. Preferably, the private social data are encrypted, at least in part, by means of an asymmetrical encryption method, in particular.

In a further embodiment, it is proposed that the first contact program outputs social data to a user, thereby making it possible to view the social data even without the main communication program. Furthermore, the social data are particularly well protected, at least in part, because they are not transmitted to the main communication program. In particular, the expression “output to a user” should be understood to mean that the first contact program displays the social data, at least in part, to the user, by way of the display of the second mobile computer.

Furthermore, it is proposed that the first contact program transmits social data to the second main communication program, and thereby the main communication program does not have to be exited to view the social data. Preferably, the first contact program writes the social data into a memory of the mobile computer, from which the second main communication program reads the data out.

Furthermore, it is proposed that the second main communication program, in at least one operating state, outputs social data from multiple contact programs to a user, and thereby the main communication program advantageously outputs an overview of the social data of multiple users of the social network. “From multiple contact programs” should particularly be understood to mean that the second main communication program, in at least one operating state, receives social data from a first contact program and from at least one broad contact program and displays them to the user.

Furthermore, it is proposed that the second main communication program and the first contact program can be executed separately from one another, and thereby particularly secure storage of the private social data in memory can be achieved. In particular, the expression “can be executed separately from one another” should be understood to mean that the main communication program and the contact program can be executed on a mobile computer, without the other program, in each instance, being installed in the mobile computer.

Furthermore, a server is proposed, which makes the first contact program available, thereby making it possible to produce a contact of the social network in particularly simple manner. In particular, a “server” should be understood to mean at least one computer that can constantly be reached at a static contact address and is particularly connected with the Internet.

Furthermore, it is proposed that the server conducts a search for a contact program, thereby making it possible for a contact program of a user to be found in advantageously simple manner. Preferably, the search for the contact program takes place using public social data.

Furthermore, a server is proposed that transmits social data to the first contact program in at least one operating state, and thereby the social data can be transmitted even if one of the mobile computers is cut off from the network.

### DRAWINGS

Further advantages are evident from the following drawing description. In the drawing, an exemplary embodiment of the invention is shown. The drawings, the description, and the claims contain multiple characteristics in combination. A person skilled in the art will also consider the characteristics individually, in practical manner, and will combine them to produce other practical combinations.

### DESCRIPTION OF THE EXEMPLARY EMBODIMENT

The FIGURE shows a system for carrying out a method according to the invention for forming a social network. The system has a first mobile computer 10, a second mobile computer 14, at least a third mobile computer 28, a first server 24, and at least a second server 26. The mobile computers 10, 14, 28 are configured as smartphones. The mobile computers 10, 14, 28 each comprise a main communication program 12, 16, 30, and two contact programs 18, 20, 32, 34, 36, 38, respectively, after the social network is formed. Each of the contact programs 18, 20, 32, 34, 36, 38 is associated with one of the main communication programs 12, 16, 30, which is installed on another one of the mobile computers 10, 14, 28. In this exemplary embodiment, two first contact programs 18, 38 are associated with a first one of the main communication programs 12. In this exemplary embodiment, two second contact programs 34, 36 are associated with a second one of the main communication programs 16. In this exemplary embodiment, two third contact programs 20, 38 are associated with a third one of the main communication programs 30. Essentially, any desired number of contact programs can be associated with one of the main communication programs 12, 16, 30. One of the mobile computers 10, 14, 28 can have essentially any number of contact programs. Each of the mobile computers 10, 14, 28 has only one of the main communication programs 12, 16, 30. The main communication programs 12, 16, 30 are provided for the purpose of transmitting social data to the contact programs 18, 20, 32, 34, 36, 38 associated with them, during operation of the social network.

The first server 24 makes at least one of the main communication programs 12 available for forming the social network. The first server 24 transmits a non-configured installation file of the main communication program 12 to the first mobile computer 10 in a first method step 42. The first main communication program 12 is installed on the first mobile computer 10. Subsequently, the first main communication program 12 is configured on the first mobile computer 10 with at least a contact address of the first mobile computer 10 and, in particular, with an identification value and public social data. Alternatively, the main communication program 12 could already be configured on the first server 24. Here, the contact address is configured as a telephone number of the first mobile computer 10.

The first main communication program 12 creates an installation file of the first contact program 18. Alternatively, the first server 24 could create an installation file of the first contact program 18. The installation file of the first contact program 18 has at least the contact address of the first mobile computer 10. Furthermore, the installation file of the first contact program 18 has a key for encrypted communication with the first main communication program 12. Furthermore, the installation file of the first contact program 18 has the identification value and the public social data of the first main communication program 12. In a next method step 44, the first main communication program 12 transmits the installation file of the first contact program 18 to the first server 24. Alternatively, the first communication program 12 could transmit the installation file of the first contact program 18 directly to another mobile computer 14, 28.

In a method step 46, the second mobile computer 14 transmits a search request with public social data, here of the first main communication program 12, to the first server 24. The first server 24 carries out a search, using the public social data, for an installation file that has the public social data, here for the installation file of the first contact program 18. In a method step 48, the server 24 transmits the installation file of the first contact program 18 to the second mobile computer 14. The second mobile computer 14 installs the first contact program 18. In this connection, the first contact program 18 stores public social data of the first main communication program 12 in memory. The first contact program 18 requests public social data from the second main communication program 16. In a method step 50, the first contact program 18 transmits the public social data of the second main communication program 16 and an authorization request to the first main communication program 12 of the first mobile computer 10.

The first main communication program 12 displays the authorization request to a user. If authorization to transmit private social data is rejected, the first main communication program 12 does not communicate with the first contact program 18. If authorization to transmit private social data is issued, the first main communication program 12 stores a contact address of the second mobile computer 14 in memory. In a method step 52, the first main communication program 12 transmits the private social data to the first contact program 18 of the second mobile computer 14. Furthermore, the first contact program 18 transmits a key for decryption of the private social data to the first contact program 18. In this connection, communication between the first main communication program 12 and the first contact program 18 is encrypted. The first contact program 18 stores the private social data in memory in encrypted form. The first contact program 18 protects the key for decryption of the private social data in a manner that appears practical to a person skilled in the art.

In at least one operating state, the second main communication program 16 outputs private social data from the first contact programs 18 and at least the third contact program 20 to a user. For this purpose, the first contact program 18 and, in particular, the third contact program 20 advantageously transmit part of the private social data directly to the second main communication program 16. It can be configured by way of the first main communication program 12 what part of the private social data is allowed to be transmitted from the first contact program 18 to the second main communication program 16. The second main communication program outputs an overview of the social data of the contact programs 18, 20 installed on the second computer 14. After output of the part of the private social data, the second main communication program 16 deletes the part of the private social data. In order for all the social data stored in memory by the first contact program 18 to be displayed, the first contact program 18 must be executed. In particular, images and videos of the first contact program 18 can be viewed only by way of the first contact program 18. For this purpose, the second main communication program 16 and the first contact program 18 can be executed separately from one another.

The contact program 18 has a security function that checks the second main communication program 16 for data security in a manner that appears practical to a person skilled in the art before transmission of the private social data. For this purpose, the second main communication program 16 is digitally signed. The contact program 18 accesses resources of the second computer 14, for example position data, contact data, and other data stored on the second computer, exclusively by way of the second main communication program 16. It can be set by means of the second main communication program 16 to what resources the first contact program 18 is allowed to have access. Furthermore, the second main communication program 16 has a security function that checks the second main communication program 16 for data security in a manner that appears practical to a person skilled in the art. For this purpose, the first contact program 18 is digitally signed.

The second server 26 is associated with the second main communication program 16. The second server 26 is associated only with the second main communication program 16. A separate such server 26 could also be associated with the first main communication program 12 and/or the third main communication program 30, in each instance. The second contact programs 34, 36 store a contact address of the second server 26 in memory. The second main communication program 16 transmits private social data and, in particular, changes in the private social data, to the second server 26 in a method step 54. The second server 26 stores the private social data in memory. The second contact programs 34, 36 call the private social data up from the second server 26 in a method step 56.

The third mobile computer 28 has a dynamically assigned contact address. The third main communication program 16 and the third contact programs 20, 38 store a contact address of a server 56 of the system in memory. When the third mobile computer 28 gets a new dynamically assigned contact address, the third main communication program 16 transmits the contact address to the third server 56 in a method step 60. One of the third contact programs 20 sends an identification value of the third main communication program 16 to the third server in a method step 62. In a method step 64, the third server answers with a current contact address of the third mobile computer 28. If other mobile computers of the system also have a dynamically assigned contact address, these can send their dynamically assigned contact address to the same server 56 of the system.

The second main communication program 16 has a function for automatic reaction to the social data transmitted by the first contact program 18. The reaction can be configured, and it can also be configured to what social data the automatic reaction is to take place. For example, the function could transmit position data to one of the second contact programs 34 in response to a request. Other reactions that appear practical to a person skilled in the art can be configured.

To dissolve part of the social network, the first main communication program 12 sends a delete instruction to the first contact program 18. The first contact program 18 deletes at least the key for decryption of the private social data. Furthermore, the first contact program 18 deletes the private social data. Furthermore, the first contact program 18 uninstalls itself.

Forming of a network having further mobile computers and communication between further mobile computers 10, 14, 28 of the network takes place in accordance with the method described for integration of the first computer 10 into the network. Characteristics and functions that were described using the example of one of the main communication programs 12, 16, 30 can therefore be demonstrated also by the other main communication programs 12, 16, 30. Characteristics and functions that were described using the example of one of the contact programs 18, 20, 32, 34, 36, 38 can therefore be demonstrated also by the other contact programs 18, 20, 32, 34, 36, 38.

### REFERENCE SYMBOL LIST

10 first mobile computer
12 first main communication program
14 second mobile computer
16 second main communication program
18 first contact program
20 third contact program
24 server
26 server
28 third mobile computer
30 third main communication program
32 first contact program
34 second contact program
36 second contact program
38 third contact program
42 method step
44 method step
46 method step
48 method step
50 method step
52 method step
54 method step
56 method step
58 server
60 method step
62 method step
64 method step

1. Method for forming a network having a first mobile computer (10) that has at least a first main communication program (12), and a second mobile computer (14) that has at least a second main communication program (16) and a first contact program (18) associated with the first main communication program (12), to which the first main communication program (12) transmits at least social data.

2. Method according to claim 1, wherein the first contact program (18) stores a contact address of the first mobile computer (10) in memory.

3. Method according to claim 1, wherein the first contact program (18) sends an authorization request to the first main communication program (12).

4. Method according to claim 1, wherein the first main communication program (12) stores a contact address of the second mobile computer (14) in memory.

5. Method according to claim 1, wherein the first main communication program (12) transmits social data to the first contact program (18).

6. Method according to claim 1, wherein the first contact program (18) stores social data in memory in encrypted form.

7. Method according to claim 1, wherein the first contact program (18) outputs social data to a user.

8. Method according to claim 1, wherein the second main communication program (16) outputs social data of multiple contact programs (18, 20) to a user in at least one operating state.

9. Method according to claim 1, wherein the second main communication program (16) and the first contact program (18) can be executed separately from one another.

10. System having at least a first mobile computer (10) and a second mobile computer (14) according to claim 1.

11. Computer for carrying out a method according to claim 1.
